(19) United States
(12) Patent Application Publication
(10) Pub. No.: US 2026/0259654 A1
(43) Pub. Date: Sep. 3, 2026

(54) System, Method, and Computer Program Product for Providing Access to a Machine-Learning Model

(71) Applicant: Clearbrief, Inc., Seattle, WA (US)

(72) Inventors: Jacqueline Grace Schafer, Seattle, WA (US); Jose Demetrio Saura, Covington, WA (US); En-Jui Chang, Seattle, WA (US)

(21) Appl. No.: 19/570,290

(22) Filed: Mar. 18, 2026

Related U.S. Application Data
(63) Continuation of application No. PCT/US26/17399, filed on Mar. 3, 2026.
(60) Provisional application No. 63/765,844, filed on Mar. 3, 2025.

(51) Int. Cl. G06F 3/04847; G06F 3/0482; G06F 40/166

(52) U.S. Cl. CPC G06F 3/04847; G06F 3/0482; G06F 40/166

(57) ABSTRACT

Provided are systems, methods, and computer program products for providing access to a machine-learning model. A system includes at least one processor configured to display a graphical user interface in a word processing application, the graphical user interface comprising at least a subset of prompts, receive a selection of a prompt from the subset of prompts from a user, execute the prompt, resulting in a model output, modify a textual document being displayed in the word processing application based on the model output, modify the prompt based on input from the user, resulting in a modified prompt, execute the modified prompt, resulting in a second model output, and store the modified prompt in the data storage device.

### CROSS REFERENCE TO RELATED APPLICATIONS

This application is a United States bypass continuation of International Application No. PCT/US26/17399, filed March 3, 2026, and claims the benefit of U.S. Provisional Patent Application No. 63/765,844, filed March 3, 2025, the disclosures of which are hereby incorporated by reference in their entireties.

### BACKGROUND

### 1. Field

This disclosure relates generally to document processing and, in some non-limiting embodiments or aspects, to systems, methods, and computer program products for providing access to a machine-learning model within a textual document.

### 2. Technical Considerations

Machine-learning models are becoming increasingly popular tools for authors of documents. Various technical challenges are posed by the use of such models, including the inability to control and/or manage how individuals within an organization are utilizing such tools and the inability to improve and/or refine the models and/or model outputs through continued usage within an organization.

### SUMMARY

According to non-limiting embodiments or aspects, provided is a system comprising: a data storage device comprising a plurality of prompts; and at least one processor configured to: display a graphical user interface in a word processing application, the graphical user interface comprising at least a subset of prompts from the plurality of prompts; receive a selection of a prompt from the subset of prompts from a user; execute the prompt, resulting in a model output; modify a textual document being displayed in the word processing application based on the model output; modify the prompt based on input from the user, resulting in a modified prompt; execute the modified prompt, resulting in a second model output; and store the modified prompt in the data storage device.

In non-limiting embodiments or aspects, the at least one processor is further configured to: generate a prompt score for each prompt of the plurality of prompts based on model outputs corresponding to the prompt. In non-limiting embodiments or aspects, executing the modified prompt further results in a score for the second model output, and the score is generated for the second model output based on at least one of the following: a number of citations in the second model output, a number of quotations in the second model output, a style detected in the second model output, a number of entities in the second model output, or any combination thereof. In non- limiting embodiments or aspects, the at least one processor is further configured to: display the modified prompt in the graphical user interface with the at least a subset of prompts. In non- limiting embodiments or aspects, the at least one processor is further configured to: generate a score for each prompt of the plurality of prompts; and display the score for each prompt of the at least a subset of prompts on the graphical user interface. In non-limiting embodiments or aspects, the at least one processor is further configured to: display a prompt editing interface configured to modify the prompt, the prompt editing interface comprising a prompt template comprising at least one selectable option configured to select a parameter from a plurality of parameters, the modified prompt is received from the prompt editing interface. In non-limiting embodiments or aspects, the at least one processor is further configured to: receive a plurality of ratings from a plurality of users for the modified prompt; and at least one of the following: display a prompt rating based on the plurality of ratings in the graphical user interface with the modified prompt, generate a score based at least partially on the plurality of ratings, or any combination thereof. In non-limiting embodiments or aspects, the at least one processor is further configured to: receive an uploaded example output document; extract structured data from the uploaded example output document; and generate or modify at least one prompt based on the structured data such that execution of the at least one prompt generates a structured document based on the uploaded example output document. In non-limiting embodiments or aspects, the plurality of prompts correspond to a plurality of different models, and wherein modifying the prompt comprises associating the prompt with a different model of the plurality of different models. In non-limiting embodiments or aspects, the at least one processor is further configured to: receive an uploaded document; and determine, based on the uploaded document, the at least a subset of prompts of the plurality of prompts. In non-limiting embodiments or aspects, the at least one processor is further configured to: process the uploaded document to determine a document signature, the at least a subset of prompts is determined based on the document signature. In non-limiting embodiments or aspects, processing the uploaded document comprises extracting structured data from the uploaded document, the structured data comprising a plurality of fields, the document signature is based on the plurality of fields.

According to non-limiting embodiments or aspects, provided is a computer- implemented method comprising: displaying a graphical user interface in a word processing application, the graphical user interface comprising at least a subset of prompts from a plurality of prompts; receiving a selection of a prompt from the subset of prompts from a user; executing the prompt, resulting in a model output; modifying a textual document being displayed in the word processing application based on the model output; modifying the prompt based on input from the user, resulting in a modified prompt; executing the modified prompt, resulting in a second model output; and storing the modified prompt in a data storage device.

In non-limiting embodiments or aspects, the method further comprises: generating a prompt score for each prompt of the plurality of prompts based on model outputs corresponding to the prompt. In non-limiting embodiments or aspects, wherein executing the modified prompt further results in a score for the second model output, and the score is generated for the second model output based on at least one of the following: a number of citations in the second model output, a number of quotations in the second model output, a style detected in the second model output, a number of entities in the second model output, or any combination thereof. In non- limiting embodiments or aspects, the method further comprising: displaying the modified prompt in the graphical user interface with the at least a subset of prompts. In non-limiting embodiments or aspects, the method further comprising: generating a score for each prompt of the plurality of prompts; and displaying the score for each prompt of the at least a subset of prompts on the graphical user interface. In non-limiting embodiments or aspects, the method further comprising: displaying a prompt editing interface configured to modify the prompt, the prompt editing interface comprising a prompt template comprising at least one selectable option configured to select a parameter from a plurality of parameters, the modified prompt is received from the prompt editing interface. In non-limiting embodiments or aspects, the method further comprising: receiving a plurality of ratings from a plurality of users for the modified prompt; and at least one of the following: displaying a prompt rating based on the plurality of ratings in the graphical user interface with the modified prompt, generating a score based at least partially on the plurality of ratings, or any combination thereof. In non-limiting embodiments or aspects, the method further comprising: receiving an uploaded example output document; extracting structured data from the uploaded example output document; and generating or modifying at least one prompt based on the structured data such that execution of the at least one prompt generates a structured document based on the uploaded example output document. In non-limiting embodiments or aspects, the plurality of prompts correspond to a plurality of different models, and wherein modifying the prompt comprises associating the prompt with a different model of the plurality of different models. In non-limiting embodiments or aspects, the method further comprising: receiving an uploaded document; and determining, based on the uploaded document, the at least a subset of prompts of the plurality of prompts. In non-limiting embodiments or aspects, the method further comprising: processing the uploaded document to determine a document signature, the at least a subset of prompts is determined based on the document signature. In non-limiting embodiments or aspects, processing the uploaded document comprises extracting structured data from the uploaded document, the structured data comprising a plurality of fields, the document signature is based on the plurality of fields.

According to non-limiting embodiments or aspects, provided is a computer program product comprising at least one non-transitory computer-readable medium including program instructions that, when executed by at least one processor, cause the at least one processor to perform the methods recited above.

According to non-limiting embodiments or aspects, provided is a system comprising: at least one data storage device comprising a plurality of prompts and at least one benchmark document; and at least one processor configured to: display a graphical user interface in a word processing application, the graphical user interface comprising a plurality of options corresponding to at least a subset of the plurality of prompts; save a new prompt with the plurality of prompts, the new prompt comprising at least one of a modified prompt or a user inputted prompt; execute the new prompt to process the at least one benchmark document; and generate a plurality of prompt metrics based on executing the new prompt to process the at least one benchmark document.

According to non-limiting embodiments or aspects, provided is a system comprising: a data storage device comprising a plurality of prompts; and at least one processor configured to: display a graphical user interface in a word processing application, the graphical user interface comprising a plurality of options corresponding to at least a subset of the plurality of prompts; receive a selection of an option from the plurality of options from a user; execute a prompt corresponding to the option, resulting in a model output; receive a modified prompt based on the prompt from the user, wherein executing the modified prompt results in a second model output different than the model output; store the modified prompt in the data storage device in association with at least one entity identifier; and providing access to the modified prompt to at least one other user based on the at least one entity identifier.

Further non-limiting embodiments and aspects are provided in the following clauses:

Clause 1: A system comprising: a data storage device comprising a plurality of prompts; and at least one processor configured to: display a graphical user interface in a word processing application, the graphical user interface comprising at least a subset of prompts from the plurality of prompts; receive a selection of a prompt from the subset of prompts from a user; execute the prompt, resulting in a model output; modify a textual document being displayed in the word processing application based on the model output; modify the prompt based on input from the user, resulting in a modified prompt; execute the modified prompt, resulting in a second model output; and store the modified prompt in the data storage device.

Clause 2: The system of clause 1, wherein the at least one processor is further configured to: generate a prompt score for each prompt of the plurality of prompts based on model outputs corresponding to the prompt.

Clause 3: The system of clause 1 or 2, wherein executing the modified prompt further results in a score for the second model output, and wherein the score is generated for the second model output based on at least one of the following: a number of citations in the second model output, a number of quotations in the second model output, a style detected in the second model output, a number of entities in the second model output, or any combination thereof.

Clause 4: The system of any of clauses 1-3, wherein the at least one processor is further configured to: display the modified prompt in the graphical user interface with the at least a subset of prompts.

Clause 5: The system of any of clauses 1-4, wherein the at least one processor is further configured to: generate a score for each prompt of the plurality of prompts; and display the score for each prompt of the at least a subset of prompts on the graphical user interface.

Clause 6: The system of any of clauses 1-5, wherein the at least one processor is further configured to: display a prompt editing interface configured to modify the prompt, the prompt editing interface comprising a prompt template comprising at least one selectable option configured to select a parameter from a plurality of parameters, wherein the modified prompt is received from the prompt editing interface.

Clause 7: The system of any of clauses 1-6, wherein the at least one processor is further configured to: receive a plurality of ratings from a plurality of users for the modified prompt; and at least one of the following: display a prompt rating based on the plurality of ratings in the graphical user interface with the modified prompt, generate a score based at least partially on the plurality of ratings, or any combination thereof.

Clause 8: The system of any of clauses 1-7, wherein the at least one processor is further configured to: receive an uploaded example output document; extract structured data from the uploaded example output document; and generate or modify at least one prompt based on the structured data such that execution of the at least one prompt generates a structured document based on the uploaded example output document.

Clause 9: The system of any of clauses 1-8, wherein the plurality of prompts correspond to a plurality of different models, and wherein modifying the prompt comprises associating the prompt with a different model of the plurality of different models.

Clause 10: The system of any of clauses 1-9, wherein the at least one processor is further configured to: receive an uploaded document; and determine, based on the uploaded document, the at least a subset of prompts of the plurality of prompts.

Clause 11: The system of any of clauses 1-10, wherein the at least one processor is further configured to: process the uploaded document to determine a document signature, wherein the at least a subset of prompts is determined based on the document signature.

Clause 12: The system of any of clauses 1-11, processing the uploaded document comprises extracting structured data from the uploaded document, the structured data comprising a plurality of fields, wherein the document signature is based on the plurality of fields.

Clause 13: A computer-implemented method comprising: displaying a graphical user interface in a word processing application, the graphical user interface comprising at least a subset of prompts from a plurality of prompts; receiving a selection of a prompt from the subset of prompts from a user; executing the prompt, resulting in a model output; modifying a textual document being displayed in the word processing application based on the model output; modifying the prompt based on input from the user, resulting in a modified prompt; executing the modified prompt, resulting in a second model output; and storing the modified prompt in a data storage device.

Clause 14: The method of clause 13, the method further comprising: generating a prompt score for each prompt of the plurality of prompts based on model outputs corresponding to the prompt.

Clause 15: The method of clause 13 or 14, wherein executing the modified prompt further results in a score for the second model output, and wherein the score is generated for the second model output based on at least one of the following: a number of citations in the second model output, a number of quotations in the second model output, a style detected in the second model output, a number of entities in the second model output, or any combination thereof.

Clause 16: The method of any of clauses 13-15, the method further comprising: displaying the modified prompt in the graphical user interface with the at least a subset of prompts.

Clause 17: The method of any of clauses 13-16, the method further comprising: generating a score for each prompt of the plurality of prompts; and displaying the score for each prompt of the at least a subset of prompts on the graphical user interface.

Clause 18: The method of any of clauses 13-17, the method further comprising: displaying a prompt editing interface configured to modify the prompt, the prompt editing interface comprising a prompt template comprising at least one selectable option configured to select a parameter from a plurality of parameters, wherein the modified prompt is received from the prompt editing interface.

Clause 19: The method of any of clauses 13-18, the method further comprising: receiving a plurality of ratings from a plurality of users for the modified prompt; and at least one of the following: displaying a prompt rating based on the plurality of ratings in the graphical user interface with the modified prompt, generating a score based at least partially on the plurality of ratings, or any combination thereof.

Clause 20: The method of any of clauses 13-19, the method further comprising: receiving an uploaded example output document; extracting structured data from the uploaded example output document; and generating or modifying at least one prompt based on the structured data such that execution of the at least one prompt generates a structured document based on the uploaded example output document.

Clause 21: The method of any of clauses 13-20, wherein the plurality of prompts correspond to a plurality of different models, and wherein modifying the prompt comprises associating the prompt with a different model of the plurality of different models.

Clause 22: The method of any of clauses 13-21, the method further comprising: receiving an uploaded document; and determining, based on the uploaded document, the at least a subset of prompts of the plurality of prompts.

Clause 23: The method of any of clauses 13-22, the method further comprising: processing the uploaded document to determine a document signature, wherein the at least a subset of prompts is determined based on the document signature.

Clause 24: The method of any of clauses 13-21, processing the uploaded document comprises extracting structured data from the uploaded document, the structured data comprising a plurality of fields, wherein the document signature is based on the plurality of fields.

Clause 25: A computer program product comprising at least one non-transitory computer-readable medium including program instructions that, when executed by at least one processor, cause the at least one processor to perform the methods of any of clauses 13-24.

Clause 26: A system comprising: at least one data storage device comprising a plurality of prompts and at least one benchmark document; and at least one processor configured to: display a graphical user interface in a word processing application, the graphical user interface comprising a plurality of options corresponding to at least a subset of the plurality of prompts; save a new prompt with the plurality of prompts, the new prompt comprising at least one of a modified prompt or a user inputted prompt; execute the new prompt to process the at least one benchmark document; and generate a plurality of prompt metrics based on executing the new prompt to process the at least one benchmark document.

Clause 27: A system comprising: a data storage device comprising a plurality of prompts; and at least one processor configured to: display a graphical user interface in a word processing application, the graphical user interface comprising a plurality of options corresponding to at least a subset of the plurality of prompts; receive a selection of an option from the plurality of options from a user; execute a prompt corresponding to the option, resulting in a model output; receive a modified prompt based on the prompt from the user, wherein executing the modified prompt results in a second model output different than the model output; store the modified prompt in the data storage device in association with at least one entity identifier; and providing access to the modified prompt to at least one other user based on the at least one entity identifier.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 illustrates a schematic diagram of a system for providing access to a machine- learning model according to non-limiting embodiments or aspects;

FIG. 2 illustrates a flow diagram for a method for providing access to a machine- learning model according to non-limiting embodiments or aspects; and

FIG. 3 illustrates example components of a device used in connection with non-limiting embodiments or aspects of systems, methods, and computer program products for providing access to a machine-learning model.

### DESCRIPTION

For purposes of the description hereinafter, the terms "end," "upper," "lower," "right," "left," "vertical," "horizontal," "top," "bottom," "lateral," "longitudinal," and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles "a" and "an" are intended to include one or more items and may be used interchangeably with "one or more" and "at least one." Furthermore, as used herein, the term "set" is intended to include one or more items (e.g., related items, unrelated items, a combination of related and unrelated items, and/or the like) and may be used interchangeably with "one or more" or "at least one." Where only one item is intended, the term "one" or similar language is used. Also, as used herein, the terms "has," "have," "having," or the like are intended to be open-ended terms. Further, the phrase "based on" is intended to mean "based at least partially on" unless explicitly stated otherwise.

As used herein, the term "computing device" may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer, server, or other form of non-mobile computer.

As used herein, the term "server" may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a "system." Reference to "a server" or "a processor," as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A textual document, such as but not limited to a legal brief, may contain many citations that reference documents (for example, content from a PDF document, word processing document such as a Word document, email file, TIFF image, and/or the like). Non-limiting embodiments described herein may provide for an improved interface for editing textual documents that provides users access to one or more machine-learning models. By integrating prompts into the document editing process and providing tools to allow users to modify prompts for processing a document being worked on, non-limiting embodiments provide for an improved, efficient use of computational resources (e.g., such as LLM (large language model) processing time). Such improvements are realized by, for example, fine-tuning prompts over time to improve the outcomes and to reduce the amount of additional prompting and/or tasks that are performed, providing improved user interfaces that allow for user manipulation of model prompts, providing a seamless integration of multiple different models, and/or providing organization-wide management and collaboration of prompts. Other improvements will be appreciated by those skilled in the art and in view of the disclosures herein.

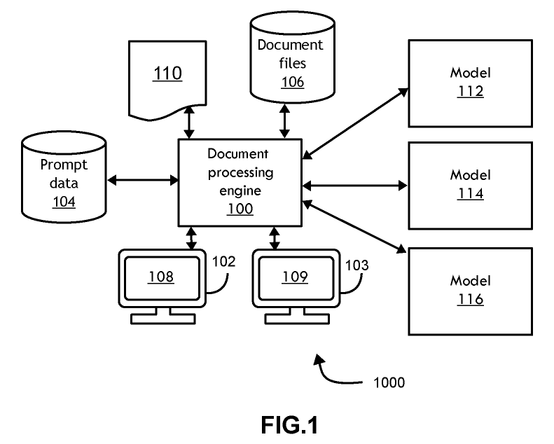

Referring now to FIG. 1, a system 1000 for providing access to a machine-learning model is shown according to non-limiting embodiments. The system 1000 includes a document processing engine 100, which may include one or more computing devices and/or software applications executed by one or more computing devices. In some non-limiting embodiments, the document processing engine 100 may be part of and/or be executed by a client computing device 102, 103. Additionally or alternatively, the document processing engine 100 may be executed by one or more servers in communication with one or more client computing devices 102, 103. For example, the document processing engine 100 may be one or more client-side applications, one or more server-side applications, or a combination of client-side and server-side applications. It will be appreciated that different arrangements of computing devices may be used in some non-limiting embodiments.

With continued reference to FIG. 1, in some non-limiting embodiments, a client computing device 102, 103 may execute a word processing application or be in communication with a word processing application service. The word processing application may display a graphical user interface (GUI) 108, 109 on the client computing device 102, 103. The GUI 108, 109 may display a textual document 110. A user of the client computing device 102, 103 may draft, edit, save, view, and interact with the textual document 110. The client computing device 102, 103 may locally store the textual document 110 and/or the textual document may be displayed from remote storage, such as from a document files database 106. The textual document 110 may also be displayed on a document reading application such that it cannot be edited but a user can select text.

In some non-limiting embodiments, the document processing engine 100 may be in communication with prompt data 104 stored on one or more data storage devices. The prompt data 104 may include a plurality of prompts for one or more machine-learning models, such as prompts for LLMs. The prompt data 104 may also include scores (e.g., ratings), different versions of prompts, notations about prompts, permissions settings for prompts, categories for prompts, and/or other like data associated with prompts for one or more machine-learning models. The prompt data 104 may be local or remote to the client computing device 102, 103 and/or document processing engine 100. Although the prompt data 104 is shown in FIG. 1 stored on a single data storage device, it will be appreciated that any number of data storage devices may be used in some non-limiting embodiments, arranged local and/or remote to the computing device 102, 103 and/or document processing engine 100.

With continued reference to FIG. 1, the document processing engine and/or another system or application may modify (e.g., edit) the textual document 110 based on the outputs of one or more machine-learning models 112, 114, 116 generated from one or more prompts. For example, a user of the computing device 102 may select a prompt from the plurality of prompts in the prompt data 104 to perform a task on the textual document 110 such as, but not limited to, citation checking, citation insertion, content generation (e.g., summaries, tables, and/or the like), content editing, and/or other like document processing and/or management tasks.

In non-limiting embodiments, a user of the computing device 102 may view a plurality of different prompts available for execution on a GUI 108. The prompts displayed on the GUI 108 may be based on a prompt category and/or a type of textual document. For example, if a textual document (e.g., textual document 110) is a legal brief, prompts associated with legal briefs (e.g., prompts with corresponding classification categories) may be displayed (e.g., citation checking, citation insertion, table of authority generation, and/or the like). If for example the textual document is a contract or form, different prompts may be presented to import data, analyze, compare with other documents, and/or the like. In some examples a user may browse through different prompts using one or more selectable options of the GUI 108.

Once a user selects a prompt, the document processing engine 100 may execute the prompt by generating a prompt query including a prompt along with any input data (e.g., a portion of the textual document that the user highlighted or is associated with the prompt) and/or context data (e.g., the type of textual document and/or type of task being performed). The document processing engine 100 may generate a prompt by, for example, inserting one or more parameters into a templated prompt. The document processing engine 100 may then execute the prompt by communicating the prompt to one or more machine-learning models 112, 114, 116.

Although FIG. 1 shows three machine-learning models 112, 114, 116, it will be appreciated that any number of models may be in communication with the document processing engine 100. Moreover, one or more machine-learning models may be local to the document processing engine 100 (e.g., such as an internally hosted model). One or more machine-learning models may be remote from the document processing engine 100 and communicated with via one or more application programming interfaces (APIs) and/or the like. In some examples, a user may select which model from a plurality of models to execute a prompt. In some examples, a prompt may be associated (e.g., preconfigured) with a specific model of a plurality of models, such that the model is part of the prompt data associated with that prompt.

Once a prompt is executed and produces an output, the document processing engine 100 may receive and process that output. For example, the document processing engine 100 may automatically use the output to modify the textual document 110. The document processing engine 100 may modify the textual document 110 based on the prompt output by, for example, inserting at least a portion of the output into the textual document, editing at least a portion of the textual document based on the output, and/or the like. The document processing engine 100 may also display one or more selectable options through the GUI 108 for the user to select from, such as different actions that can be performed on the textual document 110, different types of edits or modifications suggested for the textual document 110, and/or the like.

Still referring to FIG. 1, a user may input a score, such as a rating, into a GUI based on the result of the executed prompt. For example, in non-limiting embodiments, the user may rate the prompt within a predetermined rating system (e.g., positive or negative, number of stars, and/or the like). In non-limiting embodiments, the user may provide a narrative rating and/or comments that are converted into a rating metric and/or associated with the prompt as text. In non-limiting embodiments, the aggregate ratings from one or more users may be displayed with the prompt on the GUI 108 when a user is electing a prompt to use. In non-limiting embodiments, a user may filter prompts based on a rating. In non-limiting embodiments, ratings may be based on input from an entity or organization, one or more individuals associated with an entity or organization, and/or several different entities or organizations that utilize the prompts.

With continued reference to FIG. 1, in non-limiting embodiments, a first user (e.g., a user of the computing device 102) may modify a prompt such that the modified prompt may be used by another user (e.g., a user of the computing device 103). The other user(s) may be part of the same entity and/or organization (e.g., within the same firm or the like) in some non-limiting embodiments. For example, a user of the computing device 103 may execute a prompt for a task that is not performed as the user desires. The user may then, through the GUI, modify one or more aspects of the prompt. This may be performed by editing the text of the prompt and/or by using one or more tools configured to modify prompt parameters. In some examples, only a portion of a prompt may be editable by a user. In some examples, an entire prompt may be editable by a user. In some examples, the ability to edit a prompt may be based on one or more permissions associated with the user such that some users have permission to modify a prompt and other users do not have such permissions. In non-limiting embodiments, such permissions may be configurable by an administrative user associated with an entity or organization. A modified prompt may be stored in the prompt database 104 with the plurality of prompts. In some examples, the modified prompt may replace the original prompt in the prompt database 104. In some examples, the modified prompt may be stored as an additional version of the prompt in association with the original prompt in the prompt database 104. In some examples, the modified prompt may be stored as a new prompt in the prompt database 104.

In non-limiting embodiments, the output from a model (e.g., models 112, 114, and/or 116) may be scored based on a number of citations in the model output, a number of quotations in the model output, a style detected in the model output, a number of entities (e.g., individuals, companies, organizations, and/or the like) in the model output, or any combination thereof.

In non-limiting embodiments, a prompt editing interface may be in the form of one or more GUIs (e.g., GUIs 108, 109) including tools to modify a prompt, choose a template, and/or the like. For example, a prompt editing interface may include a prompt template including at least one selectable option configured to select a parameter from a plurality of prompt parameters, such as, but not limited to, a target portion of the textual document 110, a desired result or action, a formatting rule, an output format, and/or the like. A template may facilitate a user to create building blocks within a prompt, such as a prompt that extracts all interesting events (e.g., events relating to an input term or sentence) or a prompt that controls the output to be generated in an active voice.

In non-limiting embodiments, a user may identify and/or upload an example output document, such as a textual document that has been processed in a manner that the user desires (e.g., formatting style, citation style, and/or the like). The document processing engine 100 may extract structured data from the example output document and generate and/or modify an existing prompt based on the extracted structured data such that the prompt generates a structured document with similar features. For example, an uploaded document may be processed to obtain structured data (e.g., formatting of the document) that can then be applied as a prompt, as a layer to an existing prompt, and/or to suggest one or more prompts. In this manner, a textual document may be processed into a type of document such as, but not limited to, an investigation report, a motion, a brief, deposition outline, a witness statement, and/or the like.

For example, a user may upload a document that is being worked on (e.g., the textual document) or a document that the user wishes to use as an example document they wish to base the textual document on. The document processing engine 100 may process the uploaded document by detecting a plurality of fields and/or parameters in the document. The plurality of fields and/or parameters may represent types of information in the document and/or a structure of that information, such as names, dates, headers, and/or the like. The detected fields and/or parameters may be extracted and used to generate a document signature, which may be a concatenated and/or encoded form of the extracted fields. The document signature may then be compared to a database to find a matching document signature and corresponding suggested prompts for that type of document. For example, the document signature may be compared to document signatures for previously processed documents and suggest prompts used for those previously processed documents. In some examples the document signature may be generated by one or more models (e.g., models 112, 114, 116).

In non-limiting embodiments, one or more benchmark documents (e.g., “gold documents”) may be provided to assess the results of one mor more prompts. For example, if a user wants to experiment with a different prompt to summarize a portion of a textual document, it may be hard to compare the prompt across multiple different documents. Therefore, users may upload a benchmark document and/or select a benchmark document from preconfigured documents that can be used to test a prompt, such a prompt being modified or created by a user. One or more metrics, such as use of passive voice, length of document, tone of document, user- specified metrics, number of documents/forms extracted (e.g., a number of invoices extracted), and/or the like may be used to evaluate the prompt(s) (e.g., such as an original prompt and a modified or newly created prompt). Users may then use these metrics to evaluate the performance of the prompt, rate the prompt, and/or determine if the prompt should be used and/or shared with others. This allows users to test their prompts within the system 1000 to ensure security and to allow for the prompts to be shared with others (e.g., such as a user of the computing device 103). In some non-limiting embodiments, one or more metrics may be displayed in connection with the prompt(s) to allow users to toggle between various versions of the same prompt based on the metrics, which might be more optimal or desired for different uses and/or circumstances.

In non-limiting embodiments, all or certain users (e.g., administrative users) may be enabled to create catalogs of commonly used prompts for an entity (e.g., such as a law firm) so that various individuals can use the prompts without learning any specific prompt engineering techniques. Users working in the same organization may be able to see how others are using prompts in their system to increase the usage of such prompts and may catalog common and/or popular prompts for all users in the same organization.

In non-limiting embodiments, based on a given prompt the document processing engine 100 may evaluate and suggest modifications to one or more prompts. For example, a plain text user input or attempted prompt input may be used to translate the user-created prompt or instruction to a prompt that may produce enhanced and/or more accurate results. This may include, for example, including bullet points, controlling the voice (e.g., active or passive) of the output text, controlling the formatting of the output text, specifying a data structure and arrangement for the output, and/or the like.

In non-limiting embodiments, all or at least a portion of prompts of a plurality of prompts in the prompt database may be configured to be non-modifiable, meaning that a user is unable to change the prompt. In some examples this configuration may be applied to only a subset of prompts, such as summarization tasks, text expansion/lengthening tasks, and/or text shortening tasks, the prompts may be available on a user front-end (e.g., via the GUI 108 or the like). The document processing engine 100 may store an output from the model (e.g., model 112, 114, and/or 116) as cached data associated with the textual document 110 (e.g., within a folder assigned to a particular user, entity, and/or matter). The cached data may be stored as a form, for example. The cached data may be used to provide the output if the inputs are the same. For example, if the LLM configuration, prompt(s), and input(s) are the same as the cached output, the document processing engine 100 may output the cached data and forego prompting the LLM, thereby not wasting unnecessary computational resources to execute the LLM.

In non-limiting embodiments, all or at least a portion of prompts of a plurality of prompts in the prompt database may be configured to be modifiable, meaning that a user is able to change the prompt. In some examples, this configuration may be applied to only a subset of prompts. In non-limiting embodiments, a prompt may be modified based on feedback from a user. For example, if a user obtains a non-optimal or undesired result, the user may add additional context to improve the prompt. In non-limiting embodiments, a prompt may be modified based on a user selection of one or more options. For example, a user may select a style and/or format to be applied to a document and may use one or more tools to apply such a style and/or format to a prompt. Users may add style-based prompting to customize the writing style of the text output. In non-limiting embodiments, users may provide their own prompts. In non-limiting embodiments, a user may create one or more additional layers on existing prompts that, for example, format the output, adjust an aspect of the output, and/or the like, and such prompts may be combined (e.g., concatenated) with existing prompts or used as subsequent (e.g., follow-on) prompts used to post- process the output of the existing prompt.

In non-limiting embodiments, the GUI 108 may include a selectable option, such as a button, to view prompts that other users (e.g., user of the computing device 102) have created, modified, and/or used. The GUI 108 may include links to the documents and/or outputs processed with such prompts. In some examples, a user may filter by case, organization, issue, and/or the like.

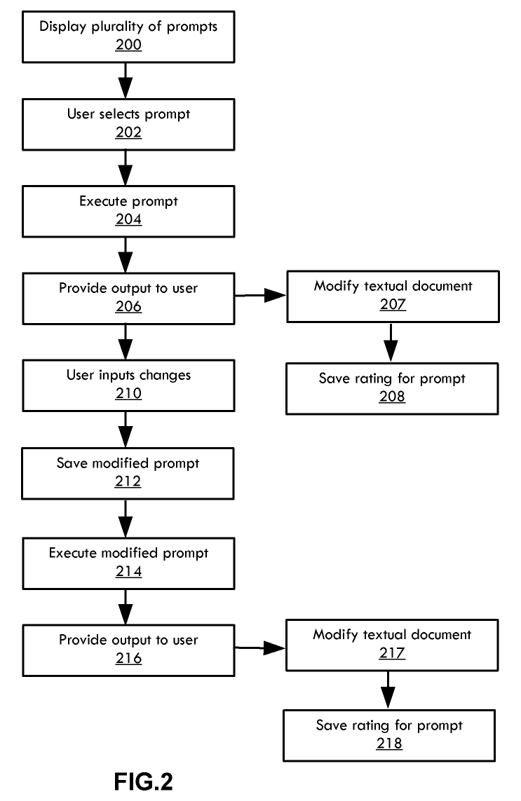

Referring now to FIG. 2, a flow chart is shown for providing access to a machine- learning model according to non-limiting embodiments. The steps shown in FIG. 2 are for example purposes only. It will be appreciated that non-limiting embodiments may involve additional steps, fewer steps, different steps, and/or a different order of steps. In some non-limiting embodiments or aspects, a step may be performed automatically in response to the completion of a previous step (e.g., may be performed without user intervention upon the completion of a previous step).

At step 200 of FIG. 2, a plurality of prompts may be displayed in a GUI. The GUI may be displayed within a word processing application as a plug-in or as integral, as examples. The prompts may be displayed based on category, task, document type, and/or the like. In some examples, the prompts may be suggested to a user based on a document that is open in the word processing application and/or other context provided by the user. At step 202, a user may select a prompt. At step 204, the prompt may be executed. For example, one or more APIs may be utilized to interface with one or more machine-learning models, such as but not limited to LLMs. In some examples, one or more machine-learning models may be hosted by a system (e.g., server computer) that performs one or more of the steps of FIG. 2. The prompt may be provided with contextual information from the textual document being viewed and/or edited, from a user profile, and/or the like.

At step 206, the output of the machine-learning model may be provided to the user. For example, the output may be presented as one or more suggested additions, modifications, and/or the like. The user may select to accept the output and the textual document may be modified at step 207 to include the output and/or based on the output. At step 208, the user may rate the prompt by rating the result of the prompt provided at steps 206 and/or 207 and the rating may be stored. For example, the prompt may receive a binary rating (e.g., positive or negative), a numerical rating (e.g., a score within a range), and/or the like. In some examples, a textual and/or narrative rating may also be provided. The rating(s) may be stored in association with the prompt. In some examples, step 206 may be combined with step 207 such that the textual document is automatically modified upon execution of the prompt and the modified document is the output the user is provided with.

With continued reference to FIG. 2, if the user does not accept the output, or if the user accepts the output but still wishes to modify the prompt, at step 210, the user may input changes. The input may include direct changes to the prompt language, selection of one or more options configured to change the prompt language, selection of one or more options configured to change one or more prompt parameters (e.g., weight of context, type of document, type of formatting, and/or the like), and/or any other input to modify the prompt. At step 212, the modified prompt may be saved in association with the existing prompt. The modified prompt may be saved as a version of the existing prompt, as a new prompt associated with the existing prompt, and/or saved over the existing prompt (e.g., replace the existing prompt). At step 214, the modified prompt may be executed on the textual document. This may be a different textual document than used for step 204 or the same textual document used for step 204. At step 216, the output of the modified prompt may be provided to the user. For example, the output may be presented as one or more suggested additions, modifications, and/or the like. The user may select to accept the output and the textual document may be modified at step 217 to include the output and/or based on the output. At step 218, the user may rate the prompt by rating the result of the prompt provided at steps 216 and/or 217 and the rating may be stored. The rating(s) may be stored in association with the modified prompt. In some examples, step 216 may be combined with step 217 such that the textual document is automatically modified upon execution of the modified prompt and the newly modified document is the output the user is provided with.

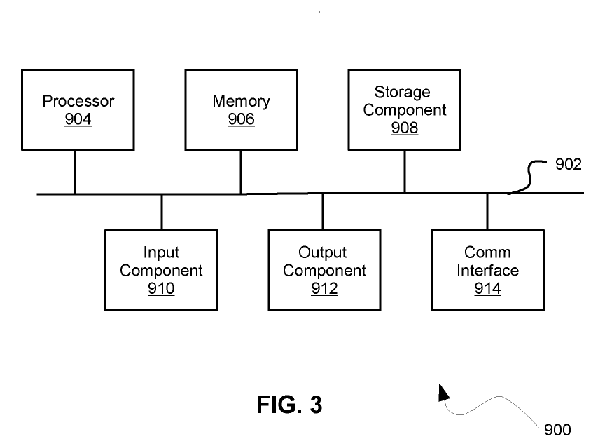

Referring now to FIG. 3, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 3. Device 900 may correspond to the computing device 102, 103 and/or document processing engine 100 shown in FIG. 1. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field- programmable gate array (FPGA), an application-specific integrated circuit (ASIC), etc.) that can be programmed or configured to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 3, storage component 908 may store information and/or software related to the operation and use of device 900. For example, storage component 908 may include a hard disk (e.g., a magnetic disk, an optical disk, a magneto-optic disk, a solid

state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer- readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term "programmed or configured," as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
a data storage device comprising a plurality of prompts; and
at least one processor configured to:
display a graphical user interface in a word processing application, the graphical user interface comprising at least a subset of prompts from the plurality of prompts;
receive a selection of a prompt from the subset of prompts from a user;
execute the prompt, resulting in a model output;
modify a textual document being displayed in the word processing application based on the model output;
modify the prompt based on input from the user, resulting in a modified prompt;
execute the modified prompt, resulting in a second model output; and store the modified prompt in the data storage device.

2. The system of claim 1, wherein the at least one processor is further configured to:
generate a prompt score for each prompt of the plurality of prompts based on model outputs corresponding to the prompt.

3. The system of claim 1, wherein executing the modified prompt further results in a score for the second model output, and wherein the score is generated for the second model output based on at least one of the following: a number of citations in the second model output, a number of quotations in the second model output, a style detected in the second model output, a number of entities in the second model output, or any combination thereof.

4. The system of claim 1, wherein the at least one processor is further configured to:
display the modified prompt in the graphical user interface with the at least a subset of prompts.

5. The system of claim 1, wherein the at least one processor is further configured to:
generate a score for each prompt of the plurality of prompts; and
display the score for each prompt of the at least a subset of prompts on the graphical user interface.

6. The system of claim 1, wherein the at least one processor is further configured to:
display a prompt editing interface configured to modify the prompt, the prompt editing interface comprising a prompt template comprising at least one selectable option configured to select a parameter from a plurality of parameters, wherein the modified prompt is received from the prompt editing interface.

7. The system of claim 1, wherein the at least one processor is further configured to:
receive a plurality of ratings from a plurality of users for the modified prompt; and
at least one of the following:
display a prompt rating based on the plurality of ratings in the graphical user interface with the modified prompt,
generate a score based at least partially on the plurality of ratings, or
any combination thereof.

8. The system of claim 1, wherein the at least one processor is further configured to:
receive an uploaded example output document;
extract structured data from the uploaded example output document; and
generate or modify at least one prompt based on the structured data such that execution of the at least one prompt generates a structured document based on the uploaded example output document.

9. The system of claim 1, wherein the plurality of prompts correspond to a plurality of different models, and wherein modifying the prompt comprises associating the prompt with a different model of the plurality of different models.

10. The system of claim 1, wherein the at least one processor is further configured to:
receive an uploaded document; and
determine, based on the uploaded document, the at least a subset of prompts of the plurality of prompts.

11. The system of claim 10, wherein the at least one processor is further configured to:
process the uploaded document to determine a document signature, wherein the at least a subset of prompts is determined based on the document signature.

12. The system of claim 11, processing the uploaded document comprises extracting structured data from the uploaded document, the structured data comprising a plurality of fields, wherein the document signature is based on the plurality of fields.

13. A computer-implemented method comprising:
displaying, with at least one computing device, a graphical user interface in a word processing application, the graphical user interface comprising at least a subset of prompts from a plurality of prompts;
receiving, with at least one computing device, a selection of a prompt from the subset of prompts from a user;
executing the prompt, resulting in a model output;
modifying, with at least one computing device, a textual document being displayed in the word processing application based on the model output;
modifying, with at least one computing device, the prompt based on input from the user, resulting in a modified prompt;
executing the modified prompt, resulting in a second model output; and
storing the modified prompt in a data storage device.

14. The method of claim 13, the method further comprising:
generating a prompt score for each prompt of the plurality of prompts based on model outputs corresponding to the prompt.

15. The method of claim 13, wherein executing the modified prompt further results in a score for the second model output, and wherein the score is generated for the second model output based on at least one of the following: a number of citations in the second model output, a number of quotations in the second model output, a style detected in the second model output, a number of entities in the second model output, or any combination thereof.

16. The method of claim 13, the method further comprising:
displaying the modified prompt in the graphical user interface with the at least a subset of prompts.

17. The method of claim 13, the method further comprising:
generating a score for each prompt of the plurality of prompts; and
displaying the score for each prompt of the at least a subset of prompts on the graphical user interface.

18. The method of claim 13, the method further comprising:
displaying a prompt editing interface configured to modify the prompt, the prompt editing interface comprising a prompt template comprising at least one selectable option configured to select a parameter from a plurality of parameters, wherein the modified prompt is received from the prompt editing interface.

19. The method of claim 13, the method further comprising:
receiving a plurality of ratings from a plurality of users for the modified prompt;
and at least one of the following:
displaying a prompt rating based on the plurality of ratings in the graphical user interface with the modified prompt,
generating a score based at least partially on the plurality of ratings, or
any combination thereof.

20. The method of claim 13, the method further comprising:
receiving an uploaded example output document;
extracting structured data from the uploaded example output document; and
generating or modifying at least one prompt based on the structured data such that execution of the at least one prompt generates a structured document based on the uploaded example output document.

21. The method of claim 13, wherein the plurality of prompts correspond to a plurality of different models, and wherein modifying the prompt comprises associating the prompt with a different model of the plurality of different models.

22. The method of claim 13, the method further comprising:
receiving an uploaded document; and
determining, based on the uploaded document, the at least a subset of prompts of the plurality of prompts.

23. The method of claim 22, the method further comprising:
processing the uploaded document to determine a document signature, wherein the at least a subset of prompts is determined based on the document signature.

24. The method of claim 11, processing the uploaded document comprises extracting structured data from the uploaded document, the structured data comprising a plurality of fields, wherein the document signature is based on the plurality of fields.

25. A computer program product comprising at least one non-transitory computer-readable medium including program instructions that, when executed by at least one processor, cause the at least one processor to:
display a graphical user interface in a word processing application, the graphical user interface comprising at least a subset of prompts from the plurality of prompts;
receive a selection of a prompt from the subset of prompts from a user;
execute the prompt, resulting in a model output;
modify a textual document being displayed in the word processing application based on the model output;
modify the prompt based on input from the user, resulting in a modified prompt;
execute the modified prompt, resulting in a second model output; and
store the modified prompt in the data storage device.
